(19) United States
(12) Patent Application Publication
(10) Pub. No.: US 2015/0240113 A1
(43) Pub. Date: Aug. 27, 2015

(54) POWDER COATING EPOXY COMPOSITIONS, METHODS, AND ARTICLES

(71) Applicant: 3N INNOVATIVE PROPERTIES COMPANY, Saint Paul, MN (US)

(72) Inventors: Jennifer K. Pratt, Round Rock, TX (US); Andrew S. D'Souza, Shoreview, MN (US); Sonja S. Mackey, St. Paul, MN (US); Rajdeep S. Kalgutkar, Woodbury, MN (US)

(21) Appl. No.: 14/427,540

(22) PCT Filed: Sep. 10, 2013
(86) PCT No.: PCT/US2013/058846

§ 371 Date: Mar. 11, 2015

Related U.S. Application Data
(60) Provisional application No. 61/702,001, filed on Sep. 17, 2012.

(51) Int. Cl. C09D 163/00; C09D 5/03

(52) U.S. Cl. CPC C09D 163/00; C09D 5/03

(57) ABSTRACT

Powder coating compositions provide protective coatings, particularly flexible coatings. Such coating compositions include a solid crosslinkable epoxy resin, core-shell rubber particles, and a filler material.

### BACKGROUND

Fusion bonded epoxy (FBE) powders and liquid resins are commonly used for corrosion protection of steel pipelines and metals used in the oil, gas, and construction industries. These coatings can be applied to a variety of parts for corrosion protection. Exemplary applications include valves, pumps, tapping saddles, manifolds, pipe hangers, ladders, mesh, rebar, cable and wire rope, I-beams, column coils, anchor plates, chairs, and the like.

A desirable FBE coating has excellent physical properties to limit damage during transit, installation, and operation. Damage to the coating can lead to higher potential corrosion of the metallic surface that the coating is protecting and can ultimately lead to a decrease in service life. Because cinders and grit can penetrate into the coating during transportation, a desirable coating has superior penetration and gouge resistance. Additionally, a desirable coating has high impact resistance from back fill or handling equipment during installation. Also, a coated substrate is often bent during installation, for example, to fit into the contour of the land, and should be flexible enough to prevent damage to the coating.

There have been several attempts to make FBE coatings more resistant to mechanical damage. For example, the thickness of the overall coating can be increased to provide added impact and abrasion absorption; however, as the thickness of the coating increases, the flexibility of the coating decreases. The filler loading can also be increased; however, higher filler loadings can dramatically decrease the flexibility of the FBE coating. As previously mentioned, the flexibility of the coating is very important during installation. Thus, a balance of properties, particularly between toughness and flexibility, is difficult but important to achieve for an FBE coating composition.

### SUMMARY

The present disclosure provides powder coating compositions, particularly fusion bonded epoxy (FBE) powder coating compositions, that provide protective epoxy coatings, particularly flexible and damage-resistant epoxy coatings. The coating compositions of the present disclosure are “powder coating compositions,” which means that they are 100% solids systems with no solvents.

Such coating compositions include a solid crosslinkable epoxy resin (i.e., a thermosetting epoxy resin powder) and core-shell rubber particles. Significantly, the addition of core-shell rubber particles dramatically increase the flexibility of a resultant coating without negatively affecting the glass transition temperature of the coating, even at high filler loadings.

In one embodiment, there is provided a powder coating composition that includes components including: a solid crosslinkable epoxy resin (i.e., a thermosetting epoxy resin powder); core-shell rubber particles in an amount of no more than 10 percent by weight (wt-%), based on the total weight of the coating composition; a curing agent; and a filler material in an amount of at least 25 wt-%, based on the total weight of the coating composition; wherein the components are selected and used in amounts to provide a cured coating having no reduction in density, or if there is a reduction in density it is by no more than 15%, relative to the theoretical density of the coating composition.

In one embodiment, there is provided a powder coating composition that includes components including: a solid crosslinkable epoxy resin having an epoxide equivalent weight of greater than 700; core-shell diene-containing rubber particles in an amount of no more than 10 wt-%, based on the total weight of the coating composition; a curing agent; and a filler material comprising inorganic, nonmetallic filler in an amount of at least 25 wt-%, based on the total weight of the coating composition; wherein the powder coating composition forms a nonporous coating when applied to a substrate and cured.

In one embodiment, there is provided a method of protecting an article, the method including: coating the article with a powder coating composition that includes components including: a solid crosslinkable epoxy resin; core-shell rubber particles in an amount of no more than 10 wt-%, based on the total weight of the coating composition; a curing agent; and a filler material; wherein the components are selected and used in amounts to provide a cured coating having no reduction in density, or if there is a reduction in density it is by no more than 15%, relative to the theoretical density of the coating composition; and curing the composition while disposed on the article.

The present disclosure also provides cured coatings and articles having a cured coating thereon.

In one embodiment, an article is provided that includes: a substrate having an outer surface; and a cured coating disposed on at least a portion of the outer surface; wherein the cured coating is prepared by curing (i.e., polymerizing and/or crosslinking) a powder coating composition of the present disclosure.

In one embodiment, an article is provided that is prepared by a method of the present disclosure.

In one embodiment, an article is provided that includes: a substrate having an outer surface; and a cured coating disposed on at least a portion of the outer surface; wherein the cured coating includes: a crosslinked epoxy resin; core-shell rubber particles incorporated in the crosslinked epoxy resin, wherein the core-shell rubber particles are present in an amount of no more than 10 wt-%, based on the total weight of the coating; and a filler material incorporated in the crosslinked epoxy resin, wherein the filler material is present in an amount of at least 25 wt-%, based on the total weight of the coating; wherein the cured coating demonstrates at least 3.0 degrees per pipe diameter per the CSA Z245.20-02-12.11 Flexibility Test at −30° C.

Herein, “room temperature” or “RT” refers to a temperature of 20° C. to 30° C. or preferably 20° C. to 25° C.

The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a perspective view of a coating disposed on a pipe substrate, in accordance with an exemplary embodiment of the present disclosure.

### DETAILED DESCRIPTION OF ILLUSTRATIVE EMBODIMENTS

The present disclosure is generally related to the field of corrosion protective epoxy coatings, particularly fusion bonded epoxy (FBE) powder coating compositions. In particular, the present disclosure relates to more flexible and damage-resistant epoxy coatings.

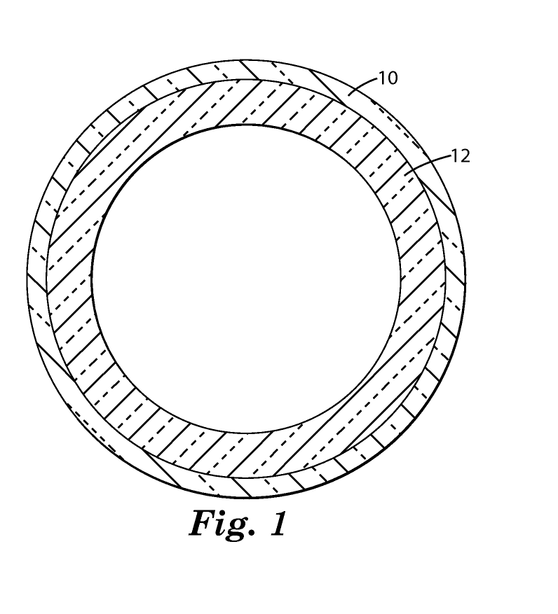

FIG. 1 is a perspective view of an FBE coating 10 of the present disclosure in use with a substrate, for example a pipe 12. Coating 10 is derived from a composition of the present disclosure that increases the elongation ability of coating 10 without negatively affecting other coating properties, such as the glass transition temperature of coating 10. The elongation ability of coating 10 results in a flexible coating that is damage resistant. Coating 10 can be a single layer or the outermost layer of a multi-layer thermoset epoxy coating and can have high impact and abrasion resistance, making coating 10 durable and capable of withstanding the normal wear and tear involved in transportation and use of a pipe 12 or other substrate. Thus, exemplary embodiments of the present disclosure provide a coating 10 that is a more flexible, damage resistant coating that maintains the toughness needed in extreme environments, such as outdoor pipelines and construction sites.

These characteristics make coating 10 particularly desirable for protecting pipes, rebar, and other metal substrates, particularly steel substrates, during transportation and use at construction sites even in extreme environmental conditions. While FIG. 1 is described in reference to a pipe as the substrate, coating 10 can be applied to any substrate, preferably a metal-containing substrate in which corrosion resistance is a desired characteristic. Such substrates include, but is not limited to, pipes, valves, pumps, tapping saddles, manifolds, pipe hangers, ladders, mesh, rebar, cable and wire rope, I-beams, column coils, anchor plates, and chairs.

A coating composition of the present disclosure can be applied to a variety of substrate surfaces. Suitable substrates include polymeric materials, glasses, ceramic materials, composite materials, and metal-containing surfaces. The coatings are particularly useful on metal-containing substrates such as metals, metal oxides, and various alloys. Steel substrates are of particular interest. The coatings can provide chemical resistance, corrosion resistance, water resistance, or a combination thereof.

A coating composition of the present disclosure could be applied directly to a substrate, e.g., a steel pipe, but could also be applied on top of one or more coatings that have better adhesion to the substrate, particularly steel. Two-layer (dual-coat or dual-layer) systems can provide unique characteristics as each layer can be designed to produce performance results that exceed those of a single-layer coating. The composition of the present disclosure is particularly suited as a top layer or top coat of a dual-layer coating system. The use of two layers, particularly two layers of fusion bonded epoxy, can significantly improve damage resistance in comparison with a single layer (i.e., single coating). The primary coating layer (i.e., layer directly coated on the substrate) is typically a coating material designed as part of a corrosion protection system. This means the primary layer has good initial adhesion and maintains adhesion after exposure to hot water or other environmental factors. The top or outermost layer can provide additional mechanical damage resistance from impact or gouging during handling, transportation, and construction. Typically, the top layer is deposited during the melt stage of the primary layer, although this is not necessary in all cases. Such multi-layered systems are described in the book entitled Fusion-Bonded Epoxy: A Foundation for Pipeline Corrosion Protection, by J. Allen Kehr, 2003, Nace Press, Chapter 3. An example of a primary layer can be prepared from 3M SCOTCHKOTE SK6233 8G a one-part, heat curable, thermosetting epoxy coating powder from 3M, St. Paul, Minn.

A composition for forming a coating 10 of the present disclosure includes components such as a solid crosslinkable epoxy resin, core-shell rubber particles, a curing agent (i.e., curative), and a filler material. Coating 10 formed of the composition has high impact and gouge resistance as well as desirable flexibility. Proper selection of the component materials and the amounts of such components is difficult yet important for achieving a balance of properties not only for the cured coating (e.g., flexibility, impact resistance, gouge resistance, and appearance), but for the coating composition (e.g., flow, processability, and scale-up).

Preferred combinations of components (in terms of selection of components and amounts of components) produce a nonporous coating once applied to a substrate and cured. In this context, “nonporous” means that the density (i.e., specific gravity) of a cured coating is reduced by no more than 15% (i.e., 0-15%), more preferably, by no more than 10% (i.e., 0-10%), and even more preferably, by no more than 5% (i.e., 0-5%), relative to the theoretical density of the coating composition. Thus, particularly preferred embodiments of the cured coating exhibit little or no reduction in density upon curing and little or no porosity. Typically, any residual porosity present in a cured coating may be caused by moisture in the composition. Porous coatings typically have poor gouge resistance. Compositions for forming nonporous coatings typically do not include components that have extensive pore-forming capabilities, such as heat expandable functional groups or fillers, blowing agents, etc.

For certain embodiments, an epoxy resin with a relatively high epoxide equivalent weight is desirable to prevent impact fusion of the powder during storage and application. Examples of suitable solid crosslinkable epoxy resins include those having an epoxide equivalent weight (EEW) of greater than 400 (for certain embodiments, preferably the EEW is greater than 700) include, but are not limited to, 1-type, 2-type, 4-type, 7-type, and 9-type Bis-A resins, and isocyanate modified epoxy resins, Novolak resins. A “type” resin is a general term referring to the advancement in molecular weight of an epoxy resin. This term is predominately used with regard to solid epoxy resins. A TYPE 1 (or 1-type) epoxy resin would have an epoxide equivalent weight (EEW) of 450 to 550, a TYPE 2 (or 2-type) resin would have and EEW of approximately 600 continuing to a TYPE 9 resin with an EEW of approximately 4000. Various combinations of epoxy resins can be used if desired. In certain embodiments, for example, as long as the composition includes an epoxy resin having an EEW of greater than 700, solid epoxy resins of lower EEW can be used, such as those of 1-type or 2-type.

An example of a particularly suitable solid crosslinkable epoxy resin includes, but is not limited to, a phenol, 4,4′-(1-methylethylidene)bis-polymer with 2,2′-[(1-methylethylidene)bis(4,1-phenylene oxymethylene)]bis[oxirane] resins. Commercially available examples of suitable solid crosslinkable epoxy 4-type Bis-A resins include, but are not limited to, those available under the trade designations: EPON 2004 and EPIKOTE 3004 from Momentive Specialty Chemicals, Inc., Columbus, Ohio; DER 664 UE and DER 664 U from Dow Chemical Co., Midland, Mich.; EPOTEC YD 903HE from Thai Epoxies, Bangkok, Thailand; NPES-904H from Kukdo Chemical Co., Ltd., Seoul Korea; GT-6084 from Huntsman Petrochemical Corp., Port Neches, Tex.; 6004 from Pacific Epoxy Polymers, Inc., Pittsfield, N.H.; and XU DT 273, GT-9045, and GT-7074 from Ciba Specialty Chemicals Corp., Greensboro, N.C. Examples of suitable solid crosslinkable 1-type Bis-A epoxy resins include, but are not limited to, those available under the trade designations: EPON 1001F from Momentive Specialty Chemicals, Inc., Columbus, Ohio; DER 6116 and DER 661 from Dow Chemical Co., Midland, Mich.; and GT-7071 and GT 9516 from Ciba Specialty Chemicals Corp., Switzerland.

Typically, a coating composition of the present disclosure includes at least 30 wt-% of a solid crosslinkable epoxy resin with an EEW of greater than 400 (for certain embodiments greater than 700), based on the total weight of the coating composition. Typically, a coating composition of the present disclosure includes no greater than 80 wt-% of a solid crosslinkable epoxy resin with an EEW of greater than 400 (for certain embodiments greater than 700), based on the total weight of the coating composition. Preferably, a coating composition of the present disclosure includes at least 40 wt-% of a solid crosslinkable epoxy resin with an EEW of greater than 400 (for certain embodiments greater than 700), based on the total weight of the coating composition. Preferably, a coating composition of the present disclosure includes no greater than 45 wt-% of a solid crosslinkable epoxy resin with an EEW of greater than 400 (for certain embodiments greater than 700), based on the total weight of the coating composition.

In certain embodiments, if a mixture of solid crosslinkable epoxy resins is used, wherein one has a low EEW (e.g., of 400 or less, or for certain embodiments 700 or less) and one has a high EEW (e.g., of greater than 400, or for certain embodiments greater than 700), typically, a coating composition of the present disclosure includes at least 3 wt-% and no greater than 20 wt-% of the lower EEW solid crosslinkable epoxy resin, based on the total weight of the coating composition. A preferred composition of the present disclosure contains no crosslinkable epoxy resin with an EEW of 400 or less (for certain embodiments 700 or less).

It has been found that adding core-shell rubber particles, particularly core-shell rubber nanoparticles, increases the elongation of the coating without negatively affecting the glass transition temperature. Suitable core-shell rubber particles are those that increase flexibility of a cured coating of the disclosure.

Preferably, the core-shell rubber particles are nanoparticles (i.e., having an average particle size of less than 1000 nanometers (nm)). Generally, the average particle size of the core-shell rubber nanoparticles is less than 500 nm, e.g., less than 300 nm, less than 200 nm, less than 100 nm, or even less than 50 nm. Typically, such particles are spherical, so the particle size is the diameter; however, if the particles are not spherical, the particle size is defined as the longest dimension of the particle.

Preferably, the core-shell rubber particles (preferably, nanoparticles) include a crosslinked rubber core and a shell that includes a thermoplastic polymer grafted to the crosslinked rubber core. The crosslinking of the core provides improved resistance to dissolution relative to the same chemistry that is either not crosslinked or not in a core-shell configuration (e.g., a linear tri-block polymer of the same or similar chemistry such as that disclosed in U.S. Pat. No. 7,670,683). Furthermore, for the same degree of flexibility, a lesser amount of crosslinked core-shell particles can be used relative to a linear tri-block polymer of the same or similar chemistry such as that disclosed in U.S. Pat. No. 7,670,683. Also, processing of a composition that includes a linear tri-block copolymer of the type disclosed in U.S. Pat. No. 7,670,683 depends on phase separation to provide toughening. This complicates the manufacturing process and can be difficult to replicate. The core-shell rubber particles can assist in solving one or more of these problems.

In certain embodiments, the shell polymer has a glass transition temperature of at least 50° C. and the rubber core has a glass transition temperature of no greater than −20° C. Herein, “rubber” refers to natural or synthetic (preferably, synthetic) elastomeric materials. In certain embodiments, the crosslinked rubber core includes an acrylate-containing rubber (e.g., a butyl acrylate rubber as in the core shell-particles disclosed in U.S. Pat. No. 6,861,475), a styrene-containing rubber, a diene-containing rubber (e.g., butadiene- and isoprene-containing rubbers), a silicone-containing rubber (e.g., such as that disclosed in U.S. Pat. App. No. 2005/124761), copolymers or combinations (e.g., mixtures or blends) thereof. In certain embodiments, the shell polymer is selected from the group consisting of an epoxy resin (e.g., a bisphenol A epoxy resin), an acrylate homopolymer, an acrylate copolymer, a styrenic homopolymer, and a styrenic copolymer. Preferred core-shell rubber particles include a crosslinked polybutadiene-containing rubber core with a grafted acrylate homopolymer shell. Exemplary core-shell rubber particles include those available under the trade designations PARALOID 21104XP and PARALOID 2691A (both of which are crosslinked poly(butadiene/styrene) core with a grafted polymethyl methacrylate shell) from Dow Chemical Co., Midland, Mich., as well as that available under the trade designation KANE ACE MX-257 (butadiene-acrylate core-shell rubber particles pre-dispersed in a bisphenol A diglycidyl liquid epoxy resin) from Kaneka Texas Corp., Pasadena, Tex. Various combinations of core-shell rubber particles can be used if desired.

Too high core-shell rubber particle content can lead to poor flow and undesirable aesthetics (e.g., lack of a smooth surface may result). Thus, core-shell rubber particles are preferably used in an amount of no more than 10 wt-% (preferably, no more than 7 wt-%, and more preferably, no more than 5 wt-%), based on the total weight of the coating composition. Typically, a coating composition of the present disclosure includes at least 1 wt-% (preferably, at least 2 wt-%) core-shell rubber particles, based on the total weight of the coating composition.

Suitable filler materials (i.e., fillers) contribute to the impact and gouge resistance of the cured coating. Examples of suitable fillers include, but are not limited to, inorganic, nonmetallic fillers, such as calcium metasilicate, barium sulfate, aluminum silicate, mica, calcium sodium aluminum silicate, calcium carbonate, titanium dioxide and combinations thereof. Herein, metallic fillers refer to fillers that are zero-valent metal particles, such as zinc powder. The filler materials can be fibrous or non-fibrous (i.e., particulate material in a form other than that of a fiber or filament).

Examples of suitable filler materials include, but are not limited to, those available under the trade designations: VANSIL W 20 and W 50 from Vanderbilt R.T. Co., Inc., Norwalk, Conn.; MINSPAR 3, 4, 7, and 10 from Kentucky-Tennessee Clay Co., Mayfield, Ky.; PURTALC 6030 from Charles B. Chrystal Co., Inc., New York, N.Y.; BARIACE B-30 and B-34 from CIMBAR, Cartersville, Ga.; Feldspar G-200, G200HP, KT4, and KT from Feldspar Corp., Atlanta, Ga.; and BUSAN 11-M1 from Buckman Laboratories, Memphis, Tenn.; and Titanium Dioxide SMC 1108 from Special Materials Co., Doylestown, Pa. Various combinations of fillers can be used if desired.

Typically, a coating composition of the present disclosure includes at least 25 wt-% of a filler material, based on the total weight of the coating composition. Preferably, a coating composition of the present disclosure includes at least 35 wt-% of a filler material, based on the total weight of the coating composition. Even more preferably, a coating composition of the present disclosure includes at least 40 wt-% of a filler material, based on the total weight of the coating composition. Even more preferably, a coating composition of the present disclosure includes at least 45 wt-% of a filler material, based on the total weight of the coating composition. Even more preferably, a coating composition of the present disclosure includes at least 50 wt-% (and often greater than 50 wt-%) of a filler material, based on the total weight of the coating composition. Alternatively stated, a preferred coating composition of the present disclosure includes at least 80 parts (and often greater than 100 parts) filler per hundred parts resin.

Too high filler loading can lead to poor flow, poor flexibility, and undesirable aesthetics (e.g., lack of a smooth surface may result). Preferably, a coating composition of the present disclosure includes no greater than 65 wt-% (and often no greater than 60 wt-%) of a filler material, based on the total weight of the coating composition.

Examples of suitable curatives (i.e., curing agents, hardeners, crosslinkers) include, but are not limited to, phenolic hardeners, dicyandiamides, imadazoles, and 3′,4′-benzophenone tetracarboxylic dianhydride. Examples of suitable commercially available curatives include, but are not limited to, those available under the trade designations: dicyandiamide AB 04 from Degussa Corp., Parsippany, N.J.; D.E.H. 85 and D.E.H. 87 Epoxy Curing Agents from Dow Chemical Corp., Midland, Mich.; DYHARD 100M dicyandiamide (“Dicy”) from AlzChem LLC, Atlanta, Ga.; and those available under the trade designations AMICURE CG, AMICURE CG-NA, AMICURE CG-325, AMICURE CG-1200, AMICURE CG-1400, DICYANEX 200-X, DICYANEX 325, and DICYANEX 1200, all of which are available from Pacific Anchor Chemical Corp., Los Angeles, Calif.

One or more curatives are used in an amount such that optimal performance properties are obtained. Typically, a coating composition of the present disclosure includes a curative or curatives added to at least 35% (preferably, at least 40%, at least 45%, at least 50%, at least 55%, or at least 60%) of the stoichiometry of the epoxy functionality of the epoxy resin. Typically, a coating composition of the present disclosure includes a curative or curatives added at no greater than 100% (preferably, no greater than 95%, no greater than 90%, no greater than 85%, no greater than 80%, no greater than 75%, no greater than 70%, or no greater than 65%) of the stoichiometry of the epoxy resin.

Depending on the application and desirable physical properties, those skilled in the art will be able to determine suitable ranges for each of the components, based on the disclosure presented herein. For example, particularly suitable component concentrations in the composition for a coating for a steel pipe substrate, where more damage resistance and less flexibility may be required, range from 40 wt-% to 45 wt-% crosslinkable solid epoxy resin, from 2 wt-% to 5 wt-% core-shell particles, from 50 wt-% to 60 wt-% filler, and with curative added from 55% to 65% of the stoichiometry of the epoxy functionality of the epoxy resin, based on the total compositional weight of the composition.

An exemplary powder coating composition for preparing a cured coating 10 of the present disclosure may also include additional materials in varying concentrations as individual needs may require. For example, the composition may further include one or more pigments, one or more catalysts, one or more flow control agents, one or more waxes, one or more fluidizing agents, one or more reactive flexibilizing agents, one or more adhesion promoters, and combinations thereof.

Examples of suitable pigments include inorganic and organic pigments. Examples of suitable inorganic pigments include, but are not limited to, carbonates, sulfides, silicates, chromates, molybdates, metals, oxides, sulfates, ferrocyanides, carbon, and combinations thereof. Examples of suitable organic pigments include, but are not limited to, azo-type (including mono-azo), vat-type, and combinations thereof. Examples of suitable commercially available pigments include, but are not limited to, Titanium Dioxide SMC 1108 from Special Materials Co., Doylestown, Pa., and Brown Iron Oxide from Rockwood Pigments, Beltsville, Md. Various combinations of pigments can be included in a coating composition of the present disclosure if desired.

If desired, a coating composition of the present disclosure can include at least 1 wt-% of a pigment, based on the total weight of the coating composition. Typically, if used, a coating composition of the present disclosure can include no greater than 2 wt-% of a pigment, based on the total weight of the coating composition.

Examples of suitable catalysts include, but are not limited to, imidazoles, anhydrides, polyamides, aliphatic amines, tertiary amines, and combinations thereof. Examples of particularly suitable catalysts include, but are not limited to, 2-methylimidazole and 2,4,6-tris dimethylamineomethyl phenol, and those available under the trade designations EPI-CURE P103 and EPI-CURE P100 from Momentive Specialty Chemicals Inc., Columbus, Ohio, or ethyl triphenylphosphonium iodine (ETPPI) from Deepwater Chemicals, Woodward, Okla. Various combinations of catalysts can be included in a coating composition of the present disclosure if desired.

Typically, a catalyst is used in an amount sufficient to cure the composition under the desired application conditions. The amount of catalyst can be varied to accommodate different application conditions. If desired, a coating composition of the present disclosure can include at least 0.1 wt-% of a catalyst, based on the total weight of the coating composition. Typically, if used, a coating composition of the present disclosure can include no greater than 1.5 wt-% of a catalyst, based on the total weight of the coating composition.

Examples of suitable flow control agents include, but are not limited to, degassing or defoaming agents, leveling agents, wetting agents, and combinations thereof. Examples of flow control agents include, but are not limited to, those available under the trade designations RESIFLOW PF-67 and RESIFLOW PL 200 from Estron Chemical, Inc., Calvert City, Ky. Various combinations of flow control agents can be included in a coating composition of the present disclosure if desired.

If desired, a coating composition of the present disclosure can include at least 0.2 wt-% of a flow control agent, based on the total weight of the coating composition. Typically, if used, a coating composition of the present disclosure can include no greater than 1.2 wt-% of a flow control agent, based on the total weight of the coating composition.

Examples of suitable fluidizing agents include fumed silicas, such as hydrophobic and hydrophilic silicas, and fumed aluminum oxides. Examples of hydrophobic fumed silicas include, but are not limited to, those available under the trade designations: N20, HDK T30, and HDK T40 from Wacker Silicones, Adrian, Mich.; and M5, HS5, E5H, and HP60 from Cabot Corp., Tuscola, Ill. Examples of hydrophilic fumed silicas include, but are not limited to, those to those available under the trade designations: H15 and H18 from Wacker Silicones, Adrian, Mich.; and CT 1221 from Cabot Corp., Tuscola, IL. An example of a fumed aluminum oxide is that available under the trade designation AEROXIDE ALU C from Evonik, Allen, Tex. Various combinations of fluidizing agents can be included in a coating composition of the present disclosure if desired.

If desired, a coating composition of the present disclosure can include at least 0.1 wt-% of a fluidizing agent, based on the total weight of the coating composition. Typically, if used, a coating composition of the present disclosure can include no greater than 1.3 wt-% of a fluidizing agent, based on the total weight of the coating composition.

Examples of suitable waxes include, but are not limited to, polyethylene wax, synthetic wax, polytetrafluoroethylene, and combinations thereof. An example of a commercially available polyethylene wax includes, but is not limited to, that available under the trade designation MPP 620F, from Micro Powders, Inc., Tarrytown, N.Y. Various combinations of waxes can be included in a coating composition of the present disclosure if desired.

If desired, a coating composition of the present disclosure can include at least 0.1 wt-% of a wax, based on the total weight of the coating composition. Typically, if used, a coating composition of the present disclosure can include no greater than 2 wt-% of a wax, based on the total weight of the coating composition.

Examples of suitable reactive flexibilizing agents include, but are not limited to, aliphatic diglycidyl ethers, silicone epoxy resins, polyglycol diglycidyl ethers, carboxylated polymers, polyamides, polyurethanes, and combinations thereof. Examples of commercially available reactive flexibilizing agents include, but are not limited to, those available under the trade designations: HELOXY 68 from Momentive Specialty Chemicals Inc., Columbus, Ohio; ERISYS GE-24 from CVC Specialty Chemicals, Moorestown, N.J.; and HYPRO 1300X13 from Emerald Performance Materials, Akron, Ohio. Various combinations of reactive flexibilizing agents can be included in a coating composition of the present disclosure if desired.

If desired, a coating composition of the present disclosure can include at least 0.1 wt-% of a reactive flexibilizing agent, based on the total weight of the coating composition. Typically, if used, a coating composition of the present disclosure can include no greater than 15 wt-% of a reactive flexibilizing agent, based on the total weight of the coating composition.

Examples of suitable adhesion promoters include, but are not limited to, amino functional metal organic adhesion promoters, mercapto functional metal organic adhesion promoters, and combinations thereof. Examples of commercially available adhesion promoters include, but are not limited to, those available under the trade designations CHARTSIL B-515.1/2H and CHARTSIL C-505.1/2H, both from Chartwell International Inc., North Attleboro, Mass. Various combinations of adhesion promoters can be included in a coating composition of the present disclosure if desired.

If desired, a coating composition of the present disclosure can include at least 0.5 wt-% of an adhesion promoter, based on the total weight of the coating composition. Typically, if used, a coating composition of the present disclosure can include no greater than 2.0 wt-% of an adhesion promoter, based on the total weight of the coating composition.

A coating 10 made from a composition of the present disclosure has desirable flexibility and resistance to cracking when bent. The combination of components, particularly the high filler loading and the core-shell particles, allows coating 10 to withstand cracking when bent at varying degrees per pipe diameter (degree/PD) at varying temperatures while maintaining a high level of gouge and impact resistance. The flexibility properties of the compositions of coating 10 are measured pursuant to a bend test provided below in the Examples Section. As is shown below, exemplary embodiments of coating 10 comply with the CSA Z245.20-06 Section 12.11 Flexibility Test at −30° C.

That is, flexibility is represented by the observation of no cracks after bending a sample coated with a preferred cured coating 10 by at least 3.0 degrees per pipe diameter per the CSA Z245.20-02-12.11 Flexibility Test at −30° C. More preferably, there are no cracks after bending a sample coated with a cured coating 10 by at least 3.5 degrees per pipe diameter per the CSA Z245.20-02-12.11 Flexibility Test at −30° C. Even more preferably, there are no cracks after bending a sample coated with a cured coating 10 by at least 4.0 degrees per pipe diameter per the CSA Z245.20-02-12.11 Flexibility Test at −30° C.

There is a significant increase in flexibility of the coating composition of the present disclosure with the addition of core-shell rubber particles at loading levels as low as 2 wt-% compared to a coating without such particles. Because the composition of coating 10 has increased flexibility, it is less brittle and prone to damage during transportation and use. Coating 10 is thus more durable and capable of withstanding abuse such as bending, even at extreme conditions such as at a temperature of −30 degrees Celsius (° C.).

A coating 10 made from a composition of the present disclosure also has suitable impact resistance and gouge resistance. The impact resistance and gouge resistance of the exemplary compositions of coating 10 are measured pursuant to a gouge resistance test and impact resistance test provided below in the Examples Section. There is little effect on gouge resistance and impact resistance with the addition of core-shell rubber particles up to a loading level of 7 wt-%.

Coating 10 may be made using a mixing and extruding process. In one exemplary embodiment, the resins, filler, and core-shell particles (and, for this example, curatives, catalysts, pigments, and flow control agents) are dry blended in a high shear mixer (Thermo Prism model number B21R 9054 STR/2041) at about 4000 revolutions per minute (rpm). After premixing, the samples are melt-mixed using a 304.8 millimeters (mm) (12 inches) co-rotating twin screw extruder model number MP-2019 15; 1 with 17-90 blocks and 2-60 blocks at a throughput range from about 50-60 grams per minute (g/min). The extruded material is then ground and classified using a commercial grinder. The median particle size of the resulting powder is typically 65 micrometers (μm)±10 μm.

In an exemplary embodiment, a dry powder epoxy coating composition of the present disclosure is then coated onto preheated (e.g., 430° F.), grit blasted, near white metal finished, hot rolled steel surfaces using a fluidized bed. The near white metal finish represents metal surfaces that are blasted to remove substantial dirt, mill scale, rust corrosion products, oxides, paint, and other foreign matter. The coating is then coated to a thickness of about 0.02 inch. The coated articles are then post cured for two minutes in a 480° F. oven and water quenched for two minutes.

### Exemplary Embodiments

Thus, the following exemplary embodiments of the present disclosure provide coating compositions, cured coatings, methods, and articles. A cured coating is more flexible and damage resistant, providing corrosion resistance to pipes, rebar, and other substrates.

1. A powder coating composition comprising components comprising:
a solid crosslinkable epoxy resin;
core-shell rubber particles in an amount of no more than 10 wt-%, based on the total weight of the coating composition;
a curing agent; and
a filler material in an amount of at least 25 wt-%, based on the total weight of the coating composition;
wherein the components are selected and used in amounts to provide a cured coating having no reduction in density, or if there is a reduction in density it is by no more than 15%, relative to the theoretical density of the coating composition.

2. The powder coating composition of embodiment 1, wherein the components are selected and used in amounts to provide a cured coating having a density that is reduced by no more than 10% relative to the theoretical density of the coating composition.

3. The powder coating composition of embodiment 1 or 2, wherein the solid crosslinkable epoxy resin comprises an epoxy resin having an epoxide equivalent weight of greater than 700.

4. The powder coating composition of any one of embodiments 1 through 3, wherein the filler material is present in an amount of at least 35 wt-%, based on the total weight of the coating composition.

5. The powder coating composition of embodiment 4, wherein the filler material is present in an amount of at least 45 wt-%, based on the total weight of the coating composition.

6. The powder coating composition of any one of embodiments 1 through 5, wherein the filler material is present in an amount of no greater than 65 wt-%, based on the total weight of the coating composition.

7. The powder coating composition of any one of embodiments 1 through 6, wherein the filler material comprises an inorganic, nonmetallic filler.

8. The powder coating composition of any one of embodiments 1 through 7, wherein the core-shell rubber particles comprise core-shell rubber nanoparticles.

9. The powder coating composition of embodiments 1 through 8, wherein the core-shell rubber particles comprise a crosslinked rubber core and a shell comprising a thermoplastic polymer grafted to the crosslinked rubber core.

10. The powder coating composition of embodiment 9, wherein the shell polymer has a glass transition temperature of at least 50° C. and the rubber core has a glass transition temperature of no greater than −20° C.

11. The powder coating composition of embodiment 9 or 10, wherein the crosslinked rubber core comprises an acrylate-containing rubber, a styrene-containing rubber, a diene-containing rubber, a silicone-containing rubber, copolymers or combinations thereof.

12. The powder coating composition of any one of embodiments 9 through 11, wherein the shell polymer is selected from the group consisting of an epoxy resin, an acrylate homopolymer, an acrylate copolymer, a styrenic homopolymer, and a styrenic copolymer.

13. The powder coating composition of embodiment 12, wherein the core-shell rubber particles comprise a crosslinked polybutadiene-containing rubber core with a grafted acrylate homopolymer shell.

14. The powder coating composition of any one of embodiments 1 through 13 which forms a nonporous coating when applied to a substrate and cured.

15. A powder coating composition comprising components comprising:
a solid crosslinkable epoxy resin having an epoxide equivalent weight of greater than 700;
core-shell diene-containing rubber particles in an amount of no more than 10 wt-%, based on the total weight of the coating composition;
a curing agent; and
a filler material comprising inorganic, nonmetallic filler in an amount of at least 25 wt-%, based on the total weight of the coating composition;
wherein the powder coating composition forms a nonporous coating when applied to a substrate and cured.

16. A cured coating comprising a reaction product of a powder coating composition of any one of embodiments 1 through 15.

17. An article comprising:
a substrate having an outer surface; and
a cured coating disposed on at least a portion of the outer surface;
wherein the cured coating is prepared by curing a powder coating composition of any one of embodiments 1 through 15.

18. A method of protecting an article, the method comprising:
coating the article with a powder coating composition comprising components comprising:
a solid crosslinkable epoxy resin;
core-shell rubber particles in an amount of no more than 10 wt-%, based on the total weight of the coating composition;
a curing agent; and
a filler material;
wherein the components are selected and used in amounts to provide a cured coating having no reduction in density, or if there is a reduction in density it is by no more than 15%, relative to the theoretical density of the coating composition; and
curing the composition while disposed on the article.

19. The method of embodiment 18, wherein the solid crosslinkable epoxy resin comprises an epoxy resin having an epoxide equivalent weight of greater than 700.

20. An article prepared by the method of embodiment 18 or 19.

21. An article comprising:
a substrate having an outer surface; and
a cured coating disposed on at least a portion of the outer surface;
wherein the cured coating comprises:
   a crosslinked epoxy resin;
   core-shell rubber particles incorporated in the crosslinked epoxy resin,
wherein the core-shell rubber particles are present in an amount of no more than 10 wt-%, based on the total weight of the coating; and
   a filler material incorporated in the crosslinked epoxy resin, wherein the filler material is present in an amount of at least 25 wt-%, based on the total
weight of the coating; and
wherein the cured coating demonstrates at least 3.0 degrees per pipe diameter per the CSA Z245.20-02-12.11 Flexibility Test at −30° C.

22. The article of embodiment 21, wherein the cured coating is the outermost layer of a dual-layer coating system.

23. The article of embodiment 21 or 22, wherein the substrate surface comprises steel.

24. The article of any one of embodiments 21 through 23, wherein the cured coating is directly coated on the steel surface.

### EXAMPLES

Samples of powder flexible epoxy resin with core shell rubber coatings were made and cured. The cured compositions were characterized via the following test procedures to establish glass transition temperature (Tg) measurement, flexibility, gouge resistance, impact resistance, gel point analysis, and hardness measurement.

### Test Methods

### Glass Transition Temperature (Tg)

Differential Scanning Calorimetry was used to measure the glass transition temperature (Tg) of the coatings. The DSC test was conducted with a TA2920 Thermal Analyzer (obtained from TA Instruments, New Castle, Del.). Testing was performed according to CSA Z245.20-10 Section 12.7.

### Flexibility

Flexibility testing was carried out according to CSA Z245.20-10 Section 12.11. Specifically, the test bars were placed in a freezer set at −30° C. for a minimum of one hour. The test bars were then bent using a mandrel specified to obtain the desired degree per pipe diameter (°/PD). Different mandrel sizes were used to give an estimate of the failure point. The highest degree per pipe diameter that passed was confirmed by repeating the test with three specimens at that °/PD. Cracks with the top 12.7 mm (0.5 inch) of the coating were disregarded.

### Gouge Resistance

The gouge resistance of the coating system was measured by placing a coated specimen on a platform that moved at a rate of three meters per minute (3 m/min). Testing was performed according to CSA Z245.20-10 Section 12.15A normal force was applied to the coating through a stylus by loading weights onto the machine. The test was conducted at increasing load values until the specimen failed. Failure was recorded when the gouge depth exceeds the coating thickness and the gouge penetrated to the bare metal. Gouge testing was performed at 23° C. using an SL-1 smooth blank bit (obtained from Fullerton Tool Company Inc., Saginaw, Mich. part no. ZB574892).

### Impact Resistance

Impact testing was conducted according to ASTM G14. This test method determines the energy required to rupture pipeline coatings under specified conditions of impact subjected to a falling weight. The radius of specified diameter impact surface, tup, used was 15.8 mm (0.62 inch). The falling weight load used was 2 kilograms (kg). Conduction of the test occurred at room temperature and at −30° C.

### Gel Point Analysis

The Gel point was measured at 204° C. and 232° C. using a draw-down tool on a calibrated hot plate. Testing was performed according to CSA Z245.20-10 Section 12.2.

### Hardness Measurement

A Shore Instrument and Manufacturing Inc Durometer Type D was used at room temperature to conduct the hardness measurement. Testing was performed according to ASTM D2240.

### Sample Preparation

Table 1 summarizes the materials used to prepare the samples of powder flexible epoxy resin with core shell rubber coatings.

TABLE 1
Summary of Materials

| Material | Description | Source |
|---|---|---|
| EPON 2004 | Solid Epoxy Resin | Momentive, Columbus, OH |
| EPON 1001F | Solid Epoxy Resin | Momentive, Columbus, OH |
| DER 664UE | Solid Epoxy Resin | Dow Chemical, Midland, MI |
| DER 343M | Solid Epoxy Resin | Dow Chemical, Midland, MI |
| PARALOID 21104XP | Core Shell Rubber Particle | Dow Chemical, Midland, MI |
| PARALOID 2691A | Core Shell Rubber Particle | Dow Chemical, Midland, MI |
| Kaneka MX-257 | Core Shell Rubber Particle | Kaneka, Pasadena, TX |
| Feldspar G200HP | Filler | Feldspar, Atlanta, GA |
| DYHARD 100M Dicy | Dicyandiamide Curative | Alzchem, Marietta, GA |
| SMC-1108 | Titanium Dioxide Pigment | SMC, New York City, NY |
| Ferroxide | Brown Iron Oxide Pigment | Rockwood Pigments, Beltsville, MD |
| RESIFLOW PF-67 | Flow Control Agent | Estron, Calvert City, KY |
| EPI-CURE P100 | Imidazole Catalyst | Momentive, Columbus, OH |
| ETPPI | Phosphonium Catalyst | Deepwater Chemicals, Woodward, |
| | | OK |
| MPP-620F | Polyethylene Wax | MicroPowders, Tarrytown, NY |
| HDK T-30 | Silica Fluidizing Agent | Wacker Solutions, Adrian, MI |
| AEROXIDE Alu C | Aluminum Oxide Flow Agent | Evonik, Allen, TX |

### Preparation of the Samples for Testing

Two-layer samples were made by coating on hot rolled steel with dimensions of 25×200×9.7 mm (1×8×⅜ inches). The steel specimens were solvent washed with methylethylketone (in accordance with SSPC-SP1) followed by an isopropanol rinse. The dry steel surface was grit blasted to a near-white finish in accordance with NACE No. 2/SSPC-SP10 1508501-5A2.5. The steel specimens were pre-heated in an oven set at 249° C. for approximately one hour. The steel specimens were dipped into 3M SCOTCHKOTE SK6233 8G a one-part, heat curable, thermosetting epoxy coating powder from 3M, St. Paul, Minn. for an appropriate length of time to give a coating thickness of approximately 15 mils. The steel specimens were then dipped into one of the top-coat fluidized bed formulations (described in Table 2) for an appropriate length of time to give a total coating thickness of 30 mils. The coated specimens were placed in a post oven set at 249° C. for two minutes. The coated specimens were then air-cooled for one minute. The coated specimens were then quenched in a water bath for two minutes.

### Preparative Example 1

### Preparation of PARALOID 2691A Core Shell Rubber Particles in Solid Epoxy Resin

In a Lancaster K-Lab mixer, 1040.7 grams of DER664UE was dry blended with 270 grams of PARALOID 2691A at 3000 rpm for one minute. After premixing, the powder was melt mixed using a Donghui-SLJ-30D 30 mm twin screw extruder at a through-put rate of 150 grams per minute. The extrudate material was sent through a chill roll and the film was subsequently crushed into flakes. The resulting material was called 20.6% PARALOID 2691A Masterbatch.

### Preparative Example 2

### Preparation of Kaneka MX-257 Core Shell Rubber Particles in Solid Epoxy Resin

A 5-L resin flask equipped with an overhead mechanical stirrer, nitrogen inlet, vacuum outlet, and temperature probe was charged with 1225 grams of DER-343M (Dow Chemical, Midland, Mich.), 856 grams of bisphenol-A (Momentive/Hexion Chemical, Columbus, Ohio), 1419 grams of MX-257 (Kaneka Corporation, Pasadena, Tex.) and 0.87 grams of ethyl triphenylphosphonium iodide (Deepwater Chemicals, Woodward, Okla.). The batch was heated to 150° C. with stirring under nitrogen. When the temperature attained 150° C., a vacuum was applied to approximately 20 mm Hg. The exothermic reaction progressed to a peak temperature of 218° C. The batch was allowed to cool spontaneously to 180° C. where it was held for about one hour with stirring under vacuum. The vacuum was broken with the introduction of nitrogen gas, the stirring halted and the batch was drained on to an aluminum tray. After cooling to ambient temperature, the material was collected and crushed into a coarse powder. The resulting material was called 15 wt-% MX-257 Masterbatch.

### Preparative Example 3

### Preparation of PARALOID 21104XP Core Shell Rubber Particles in Solid Epoxy Resin

A 2-L resin flask equipped with an overhead mechanical stirrer, nitrogen inlet, vacuum outlet, and temperature probe was charged with 456 grams of DER-343M (Dow Chemical, Freeport, Tex.), 181 grams of bisphenol-A (Momentive/Hexion Chemical, Columbus, Ohio), 113 grams of PARALOID 21104XP (Dow Chemical, Midland, Mich.) and 0.19 grams of ethyl triphenylphosphonium iodide (Deepwater Chemicals, Woodward, Okla.). The batch was purged with nitrogen using three vacuum-purge cycles. The batch was then heated to 150° C. with stirring under nitrogen. When the temperature attained 150° C., a vacuum was applied to approximately 20 mm Hg. The exothermic reaction progressed to a peak temperature of 206° C. with the addition of an additional 0.1 grams of ethyl triphenylphosphonium iodide. The batch was allowed to cool spontaneously to 180° C. where it was held for about one hour with stirring under vacuum. The vacuum was broken with the introduction of nitrogen gas, the stirring halted and the batch was drained on to an aluminum tray. After cooling to ambient temperature, the material was collected and crushed into a coarse powder. The resulting material was called 15 wt-% PARALOID 21104XP Masterbatch.

### Examples 4-9 and Comparative Example 1

All the samples were made by a mixing and extrusion process. A sample of the coating was prepared by dry bending the raw materials in a Thermo Prism model number B21R 9054 STR/2041 available from Haake at 4000 rpm. After premixing, the samples were melt mixed using a 304.8-mm (12-inch) co-rotating twin screw extruder (model number MP-2019 15:1 from Baker Perkins) with 17-90 blocks and 2-60 blocks at a through-put range from 50-60 grams/minute. The extruded material was then ground and classified using a commercial grinder. The median particle size of the resulting powder was 65 μm±10 μm.

A summary of the sample formulations is shown in Table 2 and results of sample testing are found in Table 3.

TABLE 2
Formulation Summary

| | E4 | E5 | E6 | E7 | E8 | E9 | CE1 |
|---|---|---|---|---|---|---|---|
| Material | grams | grams | grams | grams | grams | grams | Grams |
| EPON 2004 | | 139.1 | | 320.6 | 224.0 | 321.1 | 434.5 |
| EPON 1001 F | | | | | | | 35.2 |
| Feldspar G200HP | 500.0 | 500.0 | 500.0 | 500.0 | 500.0 | 500.0 | 500.0 |
| 15 wt-% MX257 | | | | | | | |
| Masterbatch | 463.6 | 324.5 | | | | | |
| 15 wt-% PARALOID | | | | | | | |
| 21104XP Masterbatch | | | 463.4 | 143.4 | | | |
| 20.6% PARALOID 2691A | | | | | | | |
| Masterbatch | | | | | 242.7 | 145.6 | |
| Dyhard 100M Dicy | 6.4 | 6.4 | 6.6 | 6.5 | 6.0 | 6.0 | 6.9 |
| SMC-1108 | 6.6 | 6.6 | 6.6 | 6.6 | 6.7 | 6.7 | 6.6 |
| Ferroxide | 6.6 | 6.6 | 6.6 | 6.6 | 6.7 | 6.7 | 6.6 |
| EPI-CURE P100 | 6.8 | 6.8 | 6.8 | 6.2 | 4.0 | 4.0 | 4.5 |
| RESIFLOW PF-67 | 10.0 | 10.0 | 10.0 | 10.0 | 10.0 | 10.0 | 4.0 |
| MPP-620F (wax) | | | | | | | 1.6 |
| AEROXIDE Alu C | 0.004 | 0.004 | 0.004 | 0.004 | 0.004 | 0.004 | |
| HDK T-30 | | | | | | | 0.005 |

TABLE 3
Sample Testing Results

| | Gel | Gel | Flexibility | | | | |
|---|---|---|---|---|---|---|---|
| | Time | Time | Highest at | | Impact | Gouge at | Tg |
| | 204° C. | 232° C. | −30° C. | Shore | Strength | 23° C. | Midpoint |
| Example | Seconds | Seconds | °/PD | D | J | kg | ° C. |
| E4 | 11 | 7 | 7.8 | 87.0 | 12 | 70.0 | 113 |
| E5 | 11 | 6 | 6.6 | 88.3 | 12 | 70.0 | 112 |
| E6 | 11 | 7 | 6.3 | 87.0 | 11 | 70.0 | 113 |
| E7 | 9 | 6 | 4.6 | 88.0 | 11 | 70.0 | 112 |
| E8 | 13 | 7 | 6.3 | 87.7 | 8 | 70.0 | 110 |
| E9 | 13 | 8 | 4.6 | 86.3 | 9 | 70.0 | 111 |
| CE1 | 14 | 7 | 2.4 | 84 | 11 | 70.0 | 111 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A powder coating composition comprising components comprising:
a solid crosslinkable epoxy resin;
core-shell rubber particles in an amount of no more than 10 wt-%, based on the total weight of the coating composition;
a curing agent; and
a filler material in an amount of at least 25 wt-%, based on the total weight of the coating composition;
wherein the components are selected and used in amounts to provide a cured coating having no reduction in density, or if there is a reduction in density it is by no more than 15%, relative to the theoretical density of the coating composition.

2. The powder coating composition of claim 1, wherein the components are selected and used in amounts to provide a cured coating having a density that is reduced by no more than 10% relative to the theoretical density of the coating composition.

3. The powder coating composition of claim 2, wherein the solid crosslinkable epoxy resin comprises an epoxy resin having an epoxide equivalent weight of greater than 700.

4. The powder coating composition of claim 1, wherein the filler material is present in an amount of at least 35 wt-%, based on the total weight of the coating composition.

5. The powder coating composition of claim 4, wherein the filler material is present in an amount of at least 45 wt-%, based on the total weight of the coating composition.

6. The powder coating composition of claim 1, wherein the filler material comprises an inorganic, nonmetallic filler.

7. The powder coating composition of claim 1, wherein the core-shell rubber particles comprise core-shell rubber nanoparticles.

8. The powder coating composition of claim 1, wherein the core-shell rubber particles comprise a crosslinked rubber core and a shell comprising a thermoplastic polymer grafted to the crosslinked rubber core.

9. The powder coating composition of claim 8, wherein the shell polymer has a glass transition temperature of at least 50° C. and the rubber core has a glass transition temperature of no greater than −20° C.

10. The powder coating composition of claim 1 which forms a nonporous coating when applied to a substrate and cured.

11. A powder coating composition comprising components comprising:
a solid crosslinkable epoxy resin having an epoxide equivalent weight of greater than 700;
core-shell diene-containing rubber particles in an amount of no more than 10 wt-%, based on the total weight of the coating composition;
a curing agent; and
a filler material comprising inorganic, nonmetallic filler in an amount of at least 25 wt-%, based on the total weight of the coating composition;
wherein the powder coating composition forms a nonporous coating when applied to a substrate and cured.

12. A cured coating comprising a reaction product of a powder coating composition of claim 1.

13. An article comprising:
a substrate having an outer surface; and
a cured coating disposed on at least a portion of the outer surface;
wherein the cured coating is prepared by curing a powder coating composition of claim 1.

14. A method of protecting an article, the method comprising:
coating the article with the powder coating composition of claim 1:
curing the composition while disposed on the article.

15. The method of claim 14, wherein the solid crosslinkable epoxy resin comprises an epoxy resin having an epoxide equivalent weight of greater than 700.

16. An article prepared by the method of claim 14.

17. (canceled)

18. The article of claim 13, wherein the cured coating is the outermost layer of a dual-layer coating system.

19. The article of claim 13, wherein the substrate surface comprises steel.

20. The article of claim 1, wherein the cured coating is directly coated on the steel surface.
